(19) United States
(12) Patent Application Publication
(10) Pub. No.: US 2020/0031282 A1
(43) Pub. Date: Jan. 30, 2020

(54) Vehicle Driving Shading Device, Vehicle and Vehicle Driving Shading Method

(71) Applicant: BOE TECHNOLOGY GROUP CO., LTD., Beijing (CN)

(72) Inventors: Zifeng WANG, Beijing (CN); Yan REN, Beijing (CN); Lei CAO, Beijing (CN); Junmin SUN, Beijing (CN); Changlin LENG, Beijing (CN)

(21) Appl. No.: 16/452,957

(22) Filed: Jun. 26, 2019

(30) Foreign Application Priority Data
Jul. 27, 2018 (CN) 201810845446.2

(51) Int. Cl. B60R 1/00; G02B 27/02; B60J 3/02

(52) U.S. Cl. CPC B60R 1/001; B60R 2011/0035; B60J 3/0286; G02B 27/026

(57) ABSTRACT

The present disclosure provides a vehicle driving shading device, a vehicle and a vehicle driving shading method. The vehicle driving shading method includes collecting light intensity of a driving environment; controlling shading rate of a shading area in a shading screen according to the light intensity of the driving environment.

### CROSS-REFERENCE TO RELATED APPLICATION

This application claims the priority of China Patent Application No. 201810845446.2, filed to the China National Intellectual Property Administration (CNIPA) on Jul. 27, 2018, the entire contents of which are hereby incorporated by reference.

### TECHNICAL FIELD

The present disclosure relates to the field of vehicle technology, and in particular to a vehicle driving shading device, a vehicle and a vehicle driving shading method.

### BACKGROUND

Vehicle driving brings convenience and fun to people, while at the same time, it is always at risk in driving.

For example, in the case of strong sunlight in the daytime, or direct glare in low-light environment, the driver's line of sight is limited, and the front object cannot be recognized. In the high-speed driving of the vehicle, instantaneous blindness of the driver may lead to a major traffic accident.

### SUMMARY

The present disclosure provides a vehicle driving shading device, a vehicle and a vehicle driving shading method.

The present disclosure provides following technical solutions:

In one aspect, an embodiment of the present disclosure provides a vehicle driving shading device, comprising: a shading screen having a shading area; a light collector, which is configured to collect light intensity of a driving environment; and a first shading adjuster, which is electrically connected to the shading screen and the light collector, respectively, and the first shading adjuster is configured to control a shading rate of the shading area in the shading screen according to the light intensity of the driving environment.

Optionally, the light intensity of the driving environment comprises first light intensity data collected at a current time and second light intensity data collected at a time that is a preset time interval earlier than the current time, the first shading adjuster comprises: a first calculating circuit, which is configured to calculate a light intensity increment of the first light intensity data compared to the second light intensity data; a first determining circuit, which is configured to determine whether the light intensity increment is greater than a first threshold; and a first shading increasing circuit, which is configured to increase the shading rate of the shading area in the shading screen if the light intensity increment is greater than the first threshold.

Optionally, the first shading adjuster comprises: a monitoring circuit, which is configured to monitor a continuous increment in the light intensity of the driving environment; a second determining circuit, which is configured to determine whether the continuous increment is greater than a second threshold; a second calculating circuit, which is configured to calculate a time difference between a current time of the continuous increment and a start time of the continuous increment if the continuous increment is greater than the second threshold; a third determining circuit, which is configured to determine whether the time difference is greater than a third threshold; and a second shading increasing circuit, which is configured to increase the shading rate of the shading area in the shading screen if the time difference is less than the third threshold.

Optionally, the first shading adjuster comprises: a fourth determining circuit, which is configured to determine whether the light intensity of the driving environment is greater than a fourth threshold; and a third shading increasing circuit, which is configured to increase the shading rate of the shading area in the shading screen if the light intensity of the driving environment is greater than the fourth threshold.

Optionally, the shading screen is selected from a group consisting of a front windshield formed by a transparent display panel, a flexible transparent display screen layer, and a liquid crystal filter layer; and wherein the liquid crystal filter layer comprises a first polarizer, a liquid crystal layer and a second polarizer which are sequentially stacked.

In another aspect, an embodiment of the present disclosure provides a vehicle, comprising: a vehicle body having a cab in the vehicle body; and a vehicle driving shading device described above.

Optionally, the vehicle driving shading device further comprises: a first image collector, which is disposed at a first relative position of the shading screen for collecting a first image outside the cab at the first relative position of the shading screen; a second image collector, which is disposed at a second relative position of the shading screen for collecting a second image in the cab at the second relative position of the shading screen; and a second shading adjuster, which is electrically connected to the first image collector and the second image collector, respectively, and the second shading adjuster is configured to analyze first position information of a light source in the first image according to the first image, analyze second position information of human eyes in the second image according to the second image, and select a position of the shading area from the shading screen according to the first relative position, the second relative position, the first position information of the light source, and the second position information of the human eyes.

Optionally, the second shading adjuster further comprises: a time acquiring circuit, which is configured to acquire a time period in which the current time is located; a fourth determining circuit, which is configured to determine whether the time period in which the current time is located is in a first time period; a setting circuit for a contour of the shading area, which is configured to set the contour of the shading area to a preset contour if the current time is in the first time period; if the current time is not in the first time period, the first position information of the light source in the first image has position information of an outer contour of the light source, and an outer contour of the shading area is generated according to the position information of the outer contour of the light source.

In another aspect, an embodiment of the present disclosure provides a vehicle driving shading method, comprising: collecting light intensity of a driving environment; controlling shading rate of a shading area in a shading screen according to the light intensity of the driving environment.

Optionally, the light intensity of the driving environment comprises first light intensity data collected at a current time and second light intensity data collected at a time that is a preset time interval earlier than the current time, a step of adjusting the shading rate of the shading area in the shading screen according to the light intensity of the driving environment comprises: calculating a light intensity increment of the first light intensity data compared to the second light intensity data; determining whether the light intensity increment is greater than a first threshold; increasing the shading rate of the shading area in the shading screen if the light intensity increment is greater than the first threshold.

Optionally, a step of adjusting the shading rate of the shading area in the shading screen according to the light intensity of the driving environment comprises: monitoring a continuous increment in the light intensity of the driving environment; determining whether the continuous increment is greater than a second threshold; calculating a time difference between a current time of the continuous increment and a start time of the continuous increment if the continuous increment is greater than the second threshold; determining whether the time difference is greater than a third threshold; and increasing the shading rate of the shading area in the shading screen if the time difference is less than the third threshold.

Optionally, the vehicle driving shading method further comprises: collecting a first image outside a cab at a first relative position of the shading screen; collecting a second image in the cab at a second relative position of the shading screen; analyzing first position information of a light source in the first image according to the first image, analyzing second position information of human eyes in the second image according to the second image, and adjusting a position of the shading area from the shading screen according to the first relative position, the second relative position, the first position information of the light source, and the second position information of the human eyes.

Optionally, the vehicle driving shading method further comprises: acquiring a time period in which the current time is located; determining whether the time period in which the current time is located is in a first time period; setting a contour of the shading area to a preset contour if the current time is in the first time period; generating an outer contour of the shading area according to position information of an outer contour of the light source if the current time is not in the first time period, wherein the first position information of the light source in the first image has the position information of the outer contour of the light source.

### BRIEF DESCRIPTION OF THE DRAWINGS

By reading the detailed description of the preferred embodiments below, various advantages and benefits will become clear to the skilled person in the art. The accompanying drawings are used only for the purpose of illustrating preferred embodiments and are not considered to be a limitation of the present disclosure. Throughout the drawings, the same components are denoted by the same reference numerals. In the drawing:

FIG. 1 is a schematic flowchart of a vehicle driving shading method provided by an embodiment of the present disclosure;

FIG. 2 is a specific schematic flowchart of a vehicle driving shading method provided by an embodiment of the present disclosure;

FIG. 3 is a specific schematic flowchart of a vehicle driving shading method provided by an embodiment of the present disclosure;

FIG. 4 is a specific schematic flowchart of a vehicle driving shading method provided by an embodiment of the present disclosure;

FIG. 5 is a structural schematic diagram of a vehicle driving shading method provided by an embodiment of the present disclosure;

FIG. 6 is a specific structural schematic diagram of a vehicle driving shading method provided by an embodiment of the present disclosure;

FIG. 7 is a specific schematic flowchart of a vehicle driving shading method provided by an embodiment of the present disclosure;

FIG. 8 is a structural schematic diagram of electrical connection of a vehicle driving shading device provided by an embodiment of the present disclosure;

FIG. 9 is a specific structural schematic diagram of electrical connection of a vehicle driving shading device provided by an embodiment of the present disclosure;

FIG. 10 is a specific structural schematic diagram of electrical connection of a vehicle driving shading device provided by an embodiment of the present disclosure;

FIG. 11 is a specific structural schematic diagram of electrical connection of a vehicle driving shading device provided by an embodiment of the present disclosure;

FIG. 12 is a structural schematic diagram of a shading screen provided by an embodiment of the present disclosure;

FIG. 13 is a structural schematic diagram of a shading screen mounted on a front windshield provided by an embodiment of the present disclosure;

FIG. 14 is a structural schematic diagram of a shading screen mounted on a front windshield provided by an embodiment of the present disclosure;

FIG. 15 is a structural schematic diagram of a vehicle provided by an embodiment of the present disclosure; and

FIG. 16 is a specific structural schematic diagram of electrical connection of a vehicle provided by an embodiment of the present disclosure.

### DETAILED DESCRIPTION OF THE EMBODIMENTS

In order to further explain the technical means and efficacy of the present disclosure for achieving the object, the specific embodiments, structures, features, and effects of a vehicle driving shading device, a vehicle and a vehicle driving shading method according to embodiments of the present disclosure will be described in detail below with reference to the accompanying drawings and preferred embodiments. In the following description, different “embodiment” or “embodiments” does not necessarily mean the same embodiment. Furthermore, the particular features, structures, or characteristics of one or more embodiments can be combined in any suitable form.

In a vehicle driving shading method provided by the embodiment, a shading rate of a shading area in a shading screen is automatically adjusted according to light intensity of a driving environment, and safety of use is high.

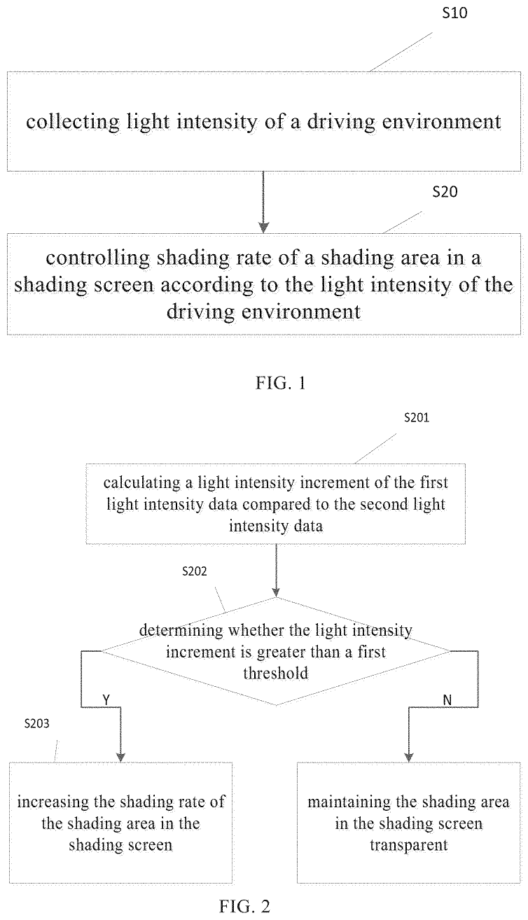

FIG. 1 is an embodiment of a vehicle driving shading method provided by the present disclosure. Referring to FIG. 1, an embodiment of the present disclosure provides a vehicle driving shading method, comprising:

S10: collecting light intensity of a driving environment.

In some embodiments, the light intensity of the driving environment may be parameters collected from light in a vehicle cab; and in other embodiments, the light intensity of the driving environment may be parameters collected from light in front of vehicle (a side of the driving direction) and outside the vehicle cab.

S20: controlling shading rate of a shading area in a shading screen according to the light intensity of the driving environment.

The driver can drive a vehicle with a shading screen in front, and the shading rate of the shading area in the shading screen is controlled by the light intensity of the driving environment being collected. When the light intensity of the driving environment exceeds a set normal driving condition, the shading rate of the shading area in the shading screen can be controlled to be lowered, and the driver's eyes are protected. Compared with the existing art, the shading rate of the shading area in the shading screen can be automatically adjusted according to driving conditions, and the safety of use is high.

Specifically, the shading rate of the shading screen may have multiple levels. For example, the shading rate may be zero at the lowest level, and the shading area is completely transparent. As the shading rate increases, the light transmittance of the shading area gradually decreases.

In some embodiments, when the light intensity of the driving environment satisfies the set normal driving condition, the shading rate of the shading area in the shading screen can be controlled to be zero, and the shading area is transparent, which does not affect the driver's field of vision.

When the light intensity of the driving environment exceeds the set normal driving condition, the human eyes feel uncomfortable with light because the sudden change of light cannot be adapted. The present disclosure proposes two solutions for eye protection methods under transient brightness enhancement. In one solution, eye protection is performed by detecting changes in light intensity over an interval of time:

The light intensity of the driving environment includes first light intensity data collected at a current time and second light intensity data collected at a time that is a preset time interval earlier than the current time. A step of adjusting the shading rate of the shading area in the shading screen according to the light intensity of the driving environment includes (as shown in FIG. 2):

S201: calculating a light intensity increment of the first light intensity data compared to the second light intensity data;

S202: determining whether the light intensity increment is greater than a first threshold;

S203: increasing the shading rate of the shading area in the shading screen if the light intensity increment is greater than the first threshold.

Specifically, the shading rate of the shading area in the shading screen may be raised to a first preset shading rate, or to a shading rate corresponding to first light intensity data. As the light intensity of the driving environment increases, the shading rate of the shading area in the shading screen gradually increases. As the light intensity of the driving environment decreases, the shading rate of the shading area in the shading screen gradually decreases. Therefore, the requirement of eye protection can be achieved.

In another solution, the eye protection is achieved by monitoring changes in light intensity.

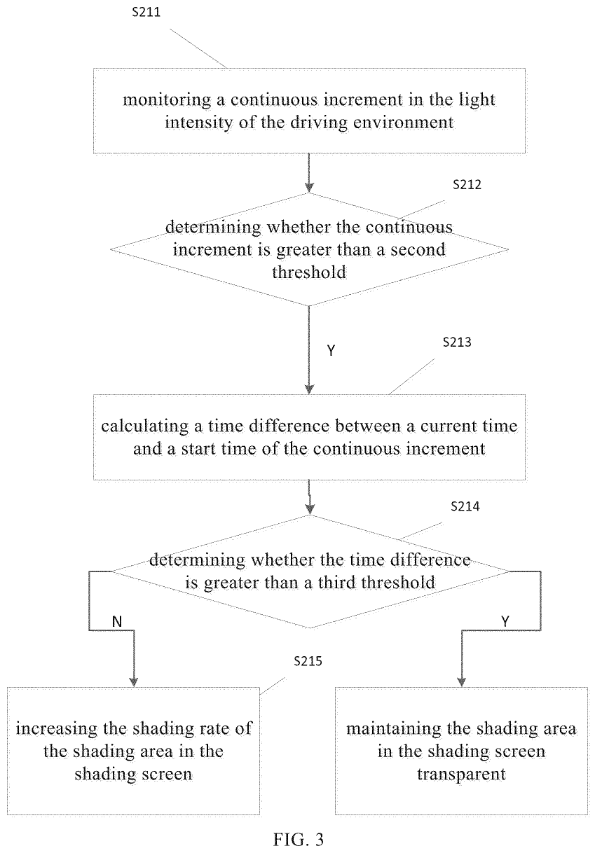

A step of adjusting the shading rate of the shading area in the shading screen according to the light intensity of the driving environment includes (as shown in FIG. 3):

S211: monitoring a continuous increment in the light intensity of the driving environment. The continuous increment may be a difference between the light intensity of the driving environment at the current time and the light intensity of the driving environment at a start time. The start time is a time corresponding to a turning point (from weak to strong) of the light intensity of the driving environment closest to the current time before the current time.

Step 211 may specifically include:

recording monitoring data of the light intensity of the driving environment at different times;

querying, from the monitoring data, a time corresponding to the turning point where the light intensity of the driving environment is turned from weak to strong closest to the current time and before the current time, and using the time as the start time; and

calculating a difference between the light intensity of the driving environment at the current time and the light intensity of the driving environment at the start time as the continuous increment.

S212: determining whether the continuous increment is greater than a second threshold;

S213: calculating a time difference between the current time of the continuous increment and a start time of the continuous increment if the continuous increment is greater than the second threshold;

S214: determining whether the time difference is greater than a third threshold; and

S215: increasing the shading rate of the shading area in the shading screen if the time difference is less than the third threshold.

Specifically, the shading rate of the shading area in the shading screen may be raised to a second preset shading rate, or to a shading rate corresponding to the light intensity of the driving environment at the current time. As the light intensity of the driving environment increases, the shading rate of the shading area in the shading screen gradually increases. As the light intensity of the driving environment decreases, the shading rate of the shading area in the shading screen gradually decreases.

Therefore, the requirement of eye protection can be achieved. Compared with the above solution, a quick response can be made in a short transient time, and the shading area can be quickly shielded from light whose light intensity changes rapidly.

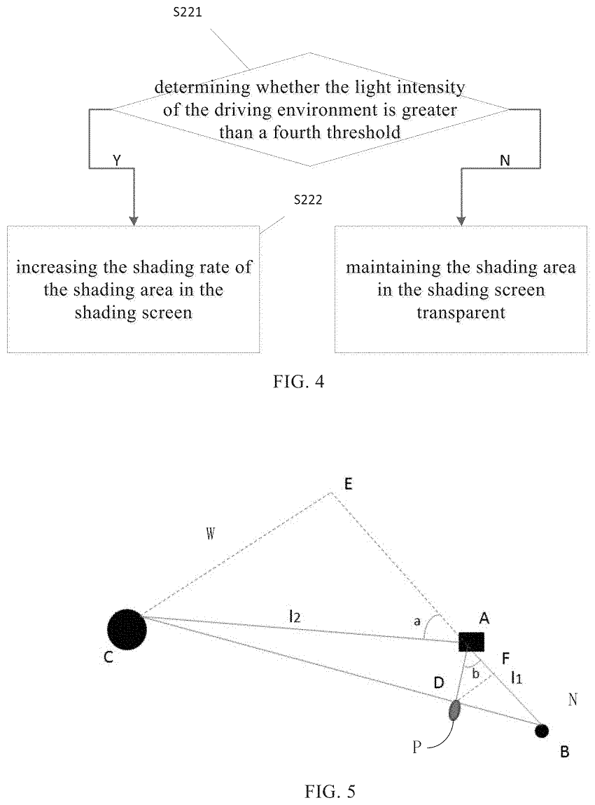

When the light intensity of the driving environment exceeds the set normal driving condition, in another solution, the human eyes are uncomfortable with glare (strong light) because the continuous glare is unacceptable. An eye protection method for continuous glare is shown in FIG. 4. A step of adjusting the shading rate of the shading area in the shading screen according to the light intensity of the driving environment includes:

S221: determining whether the light intensity of the driving environment is greater than a fourth threshold; and

S222: increasing the shading rate of the shading area in the shading screen if the light intensity of the driving environment is greater than the fourth threshold.

Specifically, the shading rate of the shading area in the shading screen may be raised to a third preset shading rate, or to a shading rate corresponding to the light intensity of the driving environment at the current time. As the light intensity of the driving environment increases, the shading rate of the shading area in the shading screen gradually increases. As the light intensity of the driving environment decreases, the shading rate of the shading area in the shading screen gradually decreases. Therefore, the requirement of eye protection can be achieved.

The shading area in the shading screen may be a set area with fixed position, and the area outside the shading area in the shading screen is a transparent area; or the shading area in the shading screen may be an area with adjustable position. The shading area in the shading screen can be changed according to position changes of the human eyes and the light source, and the area outside the shading area in the shading screen is a transparent area. Therefore, accurate shading of the light source can be achieved, as shown in FIG. 5. The vehicle driving shading method further includes:

collecting a first image outside a cab W at a first relative position of the shading screen P; the first relative position depends on the position of the shooting and the setting position of the shading screen.

Collecting a second image in the cab N at a second relative position of the shading screen P. The second relative position depends on the position of the shooting and the setting position of the shading screen. The second relative position may be the same position as the first relative position or a different position relative to the first relative position.

Analyzing first position information of a light source in the first image according to the first image, analyzing second position information of human eyes in the second image according to the second image, and adjusting a position of the shading area from the shading screen according to the first relative position, the second relative position, the first position information of the light source, and the second position information of the human eyes.

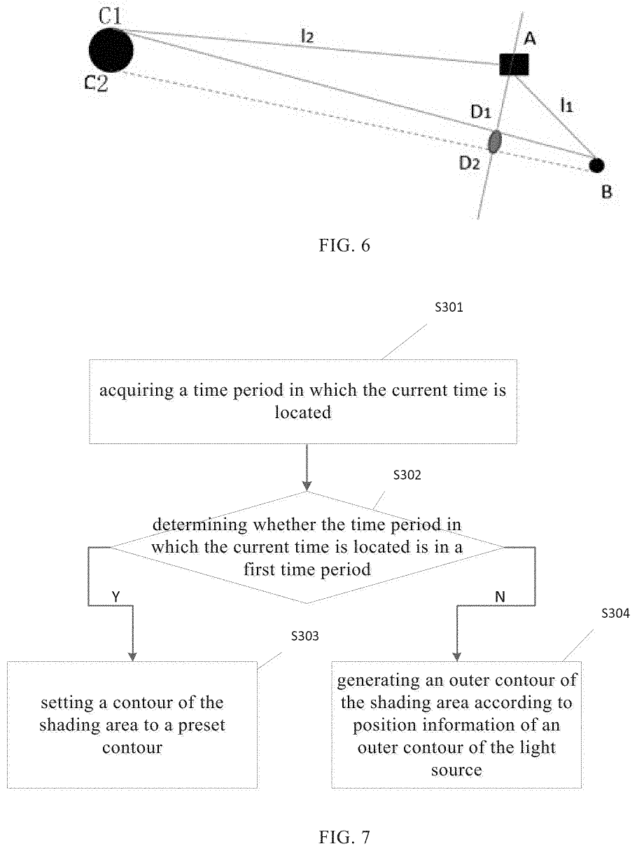

In the image analysis, the first position information includes position information of the light and distance information of the light, and the second position information includes position information of the human eyes and distance information of the human eyes. When adjusting the position of the shading area in the shading screen, the shading area in the shading screen always falls on the line connecting the first position information of the light source and the second position information of the human eyes (see FIGS. 5 and 6). The shading area is adjusted according to adjustments of the light source and the position of the human eyes. In the implementation, the first relative position and the second relative position are A, the position of the human eyes is B, the position of the light source is C, the position of the shading screen is D. A vertical line from the point C is made to the extension line of line AB, an intersection between the vertical line and the extension line is point E. A vertical line from the point D is made to the line AB, and the intersection between the vertical line and the line AB is point F. According to the first relative position and the first position information, ∠a and distance AC (12) are known. According to the second relative position and the second position information, ∠b and distance AB (11) are known. By solving: AE and CE can be obtained by 12 and ∠a; BE can be obtained by AE and 11; and ∠CBE can be obtained by BE and CE. Since DF=tag∠CBE×BF, DF/CE=BF/BE, BF, DF and AD can be obtained, the coordinates of D (the position of the shading area in the shading screen) can be finally obtained.

The outer contour of the shading area can be a set contour. In practice, the size of the light source is different in different scenes. In order to control the shading area more accurately, the first position information of the light source in the first image may include position information of an outer contour of the light source, and an outer contour of the shading area is generated according to the position information of the outer contour of the light source. As shown in FIG. 6, the position information of the outer contour of the light source includes the position information C1, C2 of a plurality of points on the outer contour of the light source. Through the above calculation, the position of each point on the outer contour of the shading area in the shading screen can be calculated by the position information of each point on the outer contour of the light source. The outer contour of the shading area can be generated by connecting the positions of the plurality of points D1 and D2 on the outer contour of the shading area. In the calculation, the outer contour of the human eyes can be a preset outer contour.

The types of light sources are different in different time periods. In some embodiments, as shown in FIG. 7, the above method includes:

S301: acquiring a time period in which the current time is located;

S302: determining whether the time period in which the current time is located is in a first time period;

S303: setting a contour of the shading area to a preset outer contour if the current time is in the first time period;

S304: generating an outer contour of the shading area according to position information of an outer contour of the light source if the current time is not in the first time period; and the first position information of the light source in the first image has the position information of the outer contour of the light source.

The first time period may be a time period of the day, such as from 6 am to 6 pm. The light source is mainly direct sunlight. As the size of the sun is almost constant, thus the contour of the shading area may be set to a preset outer contour. A time period other than the first time period, such as the second time period, may be a night time period, such as from 6 pm to 6 am. The light source is mainly vehicle light. Different vehicles have different light sizes, thus the outer contour of the shading area is a varying outer contour. The above settings meet precise shading under different vehicle conditions. Therefore, the area of the light-transmitting region is improved, and safe driving is facilitated.

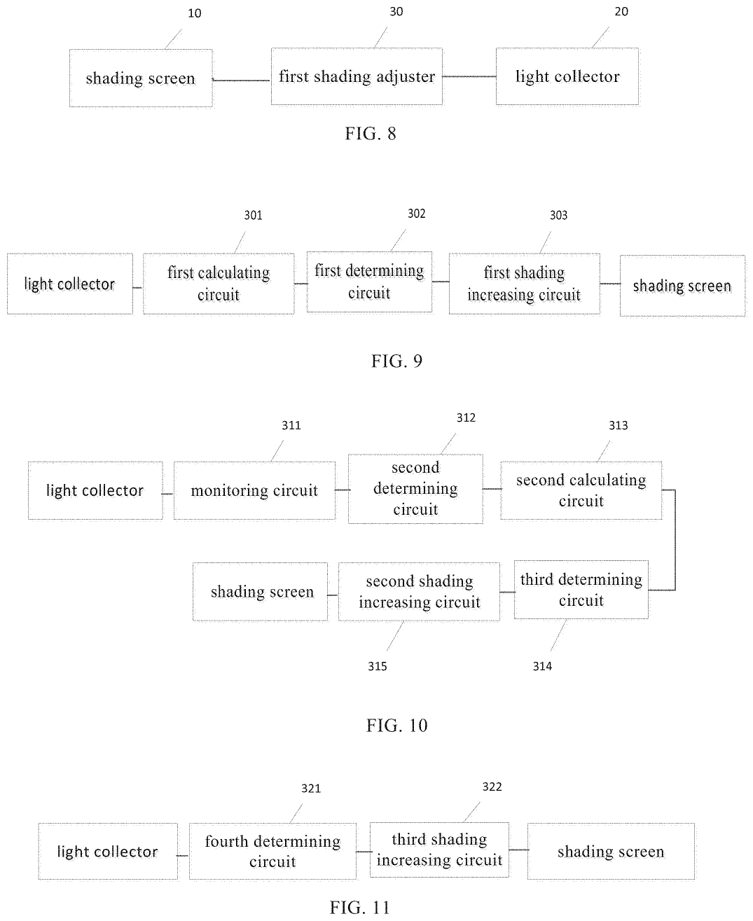

Based on the vehicle driving shading method provided by the above embodiment, FIG. 8 is an embodiment of the vehicle driving shading device provided by the present disclosure. Referring to FIG. 8, an embodiment of the present disclosure provides a vehicle driving shading device including a shading screen 10, a light collector 20 and a first shading adjuster 30.

The shading screen has a shading area. The light collector is configured to collect light intensity of a driving environment. The first shading adjuster is electrically connected to the shading screen and the light collector, respectively, and is configured to control a shading rate of the shading area in the shading screen according to the light intensity of the driving environment.

The driver can drive a vehicle with a shading screen in front, and the shading rate of the shading area in the shading screen is controlled by the light intensity of the driving environment being collected. When the light intensity of the driving environment exceeds a set normal driving condition, the shading rate of the shading area in the shading screen can be controlled to be lowered, and the driver's eyes are protected. Compared with the existing art, the shading rate of the shading area in the shading screen can be automatically adjusted according to driving conditions, and the safety of use is high.

Further, in some embodiments, the light intensity of the driving environment includes first light intensity data collected at a current time and second light intensity data collected at a time that is a preset time interval earlier than the current time. As shown in FIG. 9, the first shading adjuster includes:

a first calculating circuit 301, which is configured to calculate a light intensity increment of the first light intensity data compared to the second light intensity data;

a first determining circuit 302, which is configured to determine whether the light intensity increment is greater than a first threshold; and

a first shading increasing circuit 303, which is configured to increase the shading rate of the shading area in the shading screen if the light intensity increment is greater than the first threshold.

The first calculating circuit is connected to the light collector, and the first determining circuit is connected to the first calculating circuit and the first shading increasing circuit, respectively.

Further, in some embodiments, as shown in FIG. 10, the first shading adjuster includes:

a monitoring circuit 311, which is configured to monitor a continuous increment in the light intensity of the driving environment. The continuous increment may be a difference between the light intensity of the driving environment at the current time and the light intensity of the driving environment at a start time. The start time is a time corresponding to a turning point (from weak to strong) of the light intensity of the driving environment closest to the current time before the current time.

a second determining circuit 312, which is configured to determine whether the continuous increment is greater than a second threshold;

a second calculating circuit 313, which is configured to calculate a time difference between a current time of the continuous increment and a start time of the continuous increment if the continuous increment is greater than the second threshold;

a third determining circuit 314, which is configured to determine whether the time difference is greater than a third threshold; and

a second shading increasing circuit 315, which is configured to increase the shading rate of the shading area in the shading screen if the time difference is less than the third threshold.

The monitoring circuit is connected to the light collector, and the monitoring circuit, the second determining circuit, the second calculating circuit, the third determining circuit, and the second shading increasing circuit are connected to each other in sequence.

Further, in some embodiments, as shown in FIG. 11, the first shading adjuster includes:

a fourth determining circuit 321, which is configured to determine whether the light intensity of the driving environment is greater than a fourth threshold; and

a third shading increasing circuit 322, which is configured to increase the shading rate of the shading area in the shading screen if the light intensity of the driving environment is greater than the fourth threshold.

The fourth determining circuit is connected to the light collector, and the fourth determining circuit is connected to the third shading increasing circuit.

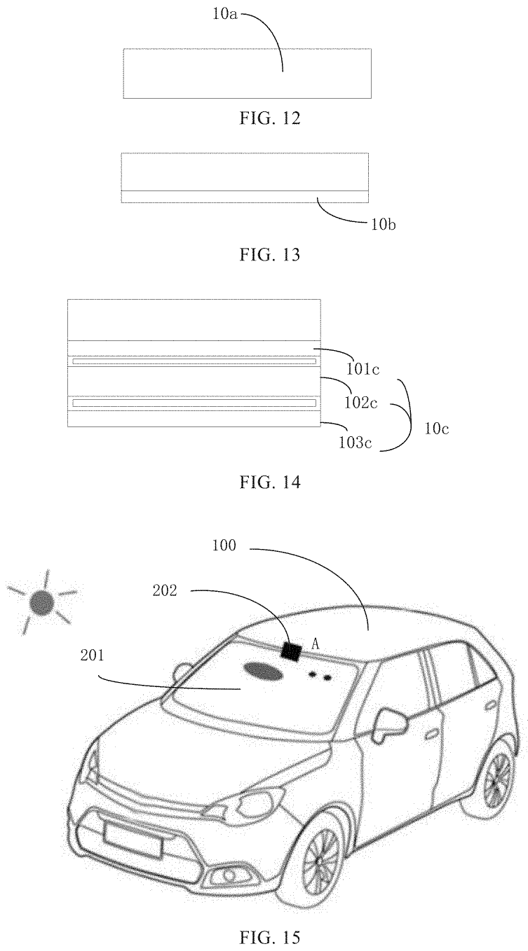

The type and size of the shading screen can be determined according to actual needs. For example, for a newly-assembled vehicle in a production line, as shown in FIG. 12, the shading screen is a vehicle front windshield 10a formed by a transparent display panel. The front windshield of the vehicle can be directly mounted to a front windshield mounting frame of the vehicle. The first shading adjuster is electrically connected to the transparent display panel, and is used for controlling the gray scale of the shading area in the transparent display panel. The light of the light source is filtered to reach an acceptable range when reaching at the human eyes, thereby achieving the effect of protecting the eyes.

As another example, for an already-assembled vehicle, the shading screen may be a layer for attaching to the front windshield of the vehicle. In some embodiments, as shown in FIG. 13, the shading screen may be a flexible transparent display screen layer 10b. The first shading adjuster is electrically connected to the flexible transparent display screen, and is used for controlling the gray scale of the shading area in the flexible transparent display screen. The light of the light source is filtered to reach an acceptable range when reaching at the human eyes, thereby achieving the effect of protecting the eyes. In other embodiments, as shown in FIG. 14, the shading screen may be a liquid crystal filter layer 10c, including a first polarizer 101c, a liquid crystal layer 102c, and a second polarizer 103c which are sequentially stacked. The first shading adjuster is electrically connected to a liquid crystal electrode of the liquid crystal layer for controlling the deflection angle of the liquid crystal. The light of the light source is filtered to reach an acceptable range when reaching at the human eyes, thereby achieving the effect of protecting the eyes.

FIG. 15 is an embodiment of a vehicle provided by the present disclosure. Referring to FIG. 15, an embodiment of the present disclosure provides a vehicle including a vehicle body 100 and a vehicle driving shading device. The vehicle body has a cab therein. The vehicle driving shading device includes a shading screen 201, a light collector 202, and a first shading adjuster (not shown). The shading screen includes a shading area. The light collector is used to collect the light intensity of the driving environment. The first shading adjuster is electrically connected to the shading screen and the light collector, respectively, for controlling a shading rate of the shading area in the shading screen according to the light intensity of the driving environment.

In a vehicle provided by the embodiment, the shading rate of the shading area in the shading screen is automatically adjusted according to light intensity of the driving environment, and safety of use is high.

The shading screen can be placed in the cab, such as hanging the shading screen in the cab, or attaching the shading screen to the front windshield of the vehicle, or installing the shading screen on the front windshield mounting frame of the vehicle.

In some embodiments, the light collector is mounted inside the cab. The light intensity of the driving environment may be parameters collected from light in a vehicle cab. In other embodiments, the light collector is mounted outside the cab, and the light intensity of the driving environment may be parameters collected from light in front of vehicle (a side of the driving direction) and outside the vehicle cab.

Further, in the vehicle provided in the above embodiment, the vehicle driving shading device further includes:

a first image collector, which is disposed at a first relative position A of the shading screen for collecting a first image outside the cab at the first relative position of the shading screen;

a second image collector, which is disposed at a second relative position A of the shading screen for collecting a second image in the cab at the second relative position of the shading screen; and

a second shading adjuster, which is electrically connected to the first image collector and the second image collector, respectively; the second shading adjuster is configured to analyze first position information of a light source in the first image according to the first image, analyze second position information of human eyes in the second image according to the second image, and select a position of the shading area from the shading screen according to the first relative position, the second relative position, the first position information of the light source, and the second position information of the human eyes.

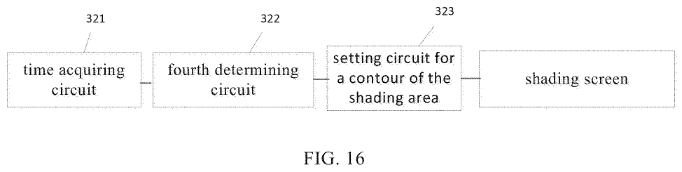

Further, in the vehicle provided in the above embodiment, as shown in FIG. 16, second shading adjuster further includes:

a time acquiring circuit 321, which is configured to acquire a time period in which the current time is located;

a fourth determining circuit 322, which is configured to determine whether the time period in which the current time is located is in a first time period; and

a setting circuit 323 for a contour of the shading area, which is configured to set the contour of the shading area to a preset contour if the current time is in the first time period.

If the current time is not in the first time period, the first position information of the light source in the first image has position information of an outer contour of the light source, and an outer contour of the shading area is generated according to the position information of the outer contour of the light source.

The time acquiring circuit, the fourth determining circuit, and the setting circuit for the contour of the shading area are sequentially connected.

In the above embodiments, the descriptions of the various embodiments are different, and the details that are not detailed in a certain embodiment can be referred to the related descriptions of other embodiments.

It will be appreciated that related features in the above described devices may be referenced to each other. In addition, “first”, “second”, and the like in the above embodiments are used to distinguish the embodiments, and do not represent the advantages and disadvantages of the embodiments.

In the description provided herein, numerous specific details are set forth. However, it is understood that the embodiments of the present disclosure may be practiced without these specific details. In some instances, well-known structures and techniques have not been shown in detail so as not to obscure the understanding of the description.

Similarly, it should be understood that, in order to streamline the present disclosure and help to understand one or more of the various aspects of the disclosure, in the description of the exemplary embodiments of the present disclosure above, the various features of the present disclosure are sometimes grouped together into a single embodiment, a diagram, or a description thereof. However, the disclosed device should not be interpreted as reflecting the intention that the claimed disclosure requires more features than are explicitly recorded in each claim. More precisely, as reflected in the following claims, the disclosure aspect is less than all the features of a single embodiment previously disclosed. Therefore, the claims that follow the specific embodiments are explicitly incorporated into the specific embodiments, in which each claim itself is a separate embodiment of the present disclosure.

Those skilled in the art will appreciate that the components of the apparatus in the embodiments can be adaptively changed and placed in one or more devices different from the embodiment. The components of the embodiment can be combined into one component and, in addition, they can be divided into a plurality of sub-components. In addition to the mutual exclusion of at least some of such features, all of the features disclosed in the specification (including the accompanying claims, the abstract and the drawings) and all components of any device so disclosed may be combined in any combination. Each feature disclosed in this specification (including the accompanying claims, the abstract, and the drawings) may be replaced by the alternative features that provide the same, equivalent or similar purpose.

In addition, those skilled in the art will appreciate that, although some embodiments described herein include certain features that are included in other embodiments and not in other features, combinations of features of different embodiments are intended to be within the scope of the present disclosure, and form a different embodiment. For example, in the following claims, any one of the claimed embodiments can be used in any combination. Various components in embodiments of the present disclosure may be implemented in hardware or in a combination thereof.

It should be noted that the above-described embodiments are illustrative of the present disclosure and are not intended to limit the scope of the disclosure, and those skilled in the art can devise alternative embodiments without departing from the scope of the appended claims. In the claims, any reference signs placed between parentheses shall not be construed as a limitation. The word “comprising” does not exclude the presence of a component or assembly that is not listed in the claims. The word “a” or “an” preceding a component or component does not exclude the presence of a plurality of such components or assemblies. The present disclosure can be implemented by means of a device comprising several distinct components. In the claims enumerating several components, several of these components may be embodied by the same component item. The use of the words first, second, and third does not indicate any order. These words can be interpreted as names.

The above description is only a preferred embodiment of the present disclosure, and is not intended to limit the present disclosure in any way. Any simple amendments, equivalent changes and modifications made to the above embodiments in accordance with the technical spirit of the present disclosure are still within the scope of the disclosed technical solutions.

What is claimed is:

1. A vehicle driving shading device, comprising:
a shading screen having a shading area;
a light collector, which is configured to collect light intensity of a driving environment; and
a first shading adjuster, which is electrically connected to the shading screen and the light collector, respectively, and the first shading adjuster is configured to control a shading rate of the shading area in the shading screen according to the light intensity of the driving environment.

2. The vehicle driving shading device according to claim 1, wherein the light intensity of the driving environment comprises first light intensity data collected at a current time and second light intensity data collected at a time that is a preset time interval earlier than the current time, the first shading adjuster comprises:
a first calculating circuit, which is configured to calculate a light intensity increment of the first light intensity data compared to the second light intensity data;
a first determining circuit, which is configured to determine whether the light intensity increment is greater than a first threshold; and
a first shading increasing circuit, which is configured to increase the shading rate of the shading area in the shading screen if the light intensity increment is greater than the first threshold.

3. The vehicle driving shading device according to claim 1, wherein the first shading adjuster comprises:
a monitoring circuit, which is configured to monitor a continuous increment in the light intensity of the driving environment;
a second determining circuit, which is configured to determine whether the continuous increment is greater than a second threshold;
a second calculating circuit, which is configured to calculate a time difference between a current time of the continuous increment and a start time of the continuous increment if the continuous increment is greater than the second threshold;
a third determining circuit, which is configured to determine whether the time difference is greater than a third threshold; and
a second shading increasing circuit, which is configured to increase the shading rate of the shading area in the shading screen if the time difference is less than the third threshold.

4. The vehicle driving shading device according to claim 1, wherein the first shading adjuster comprises:
a fourth determining circuit, which is configured to determine whether the light intensity of the driving environment is greater than a fourth threshold; and
a third shading increasing circuit, which is configured to increase the shading rate of the shading area in the shading screen if the light intensity of the driving environment is greater than the fourth threshold.

5. The vehicle driving shading device according to claim 1, wherein the shading screen is selected from a group consisting of a front windshield formed by a transparent display panel, a flexible transparent display screen layer, and a liquid crystal filter layer; and
wherein the liquid crystal filter layer comprises a first polarizer, a liquid crystal layer and a second polarizer which are sequentially stacked.

6. The vehicle driving shading device according to claim 2, wherein the shading screen is selected from a group consisting of a front windshield formed by a transparent display panel, a flexible transparent display screen layer, and a liquid crystal filter layer; and
wherein the liquid crystal filter layer comprises a first polarizer, a liquid crystal layer and a second polarizer which are sequentially stacked.

7. The vehicle driving shading device according to claim 3, wherein the shading screen is selected from a group consisting of a front windshield formed by a transparent display panel, a flexible transparent display screen layer, and a liquid crystal filter layer; and
wherein the liquid crystal filter layer comprises a first polarizer, a liquid crystal layer and a second polarizer which are sequentially stacked.

8. The vehicle driving shading device according to claim 4, wherein the shading screen is selected from a group consisting of a front windshield formed by a transparent display panel, a flexible transparent display screen layer, and a liquid crystal filter layer; and
wherein the liquid crystal filter layer comprises a first polarizer, a liquid crystal layer and a second polarizer which are sequentially stacked.

9. A vehicle, comprising:
a vehicle body having a cab in the vehicle body; and
a vehicle driving shading device according to claim 1.

10. The vehicle according to claim 9, wherein the vehicle driving shading device further comprises:
a first image collector, which is disposed at a first relative position of the shading screen for collecting a first image outside the cab at the first relative position of the shading screen;
a second image collector, which is disposed at a second relative position of the shading screen for collecting a second image in the cab at the second relative position of the shading screen; and
a second shading adjuster, which is electrically connected to the first image collector and the second image collector, respectively, and the second shading adjuster is configured to analyze first position information of a light source in the first image according to the first image, analyze second position information of human eyes in the second image according to the second image, and select a position of the shading area from the shading screen according to the first relative position, the second relative position, the first position information of the light source, and the second position information of the human eyes.

11. The vehicle according to claim 10, wherein the second shading adjuster further comprises:
a time acquiring circuit, which is configured to acquire a time period in which the current time is located;
a fourth determining circuit, which is configured to determine whether the time period in which the current time is located is in a first time period;
a setting circuit for a contour of the shading area, which is configured to set the contour of the shading area to a preset contour if the current time is in the first time period;
if the current time is not in the first time period, the first position information of the light source in the first image has position information of an outer contour of the light source, and an outer contour of the shading area is generated according to the position information of the outer contour of the light source.

12. A vehicle driving shading method, comprising:
collecting light intensity of a driving environment;
controlling shading rate of a shading area in a shading screen according to the light intensity of the driving environment.

13. The vehicle driving shading method according to claim 12, wherein the light intensity of the driving environment comprises first light intensity data collected at a current time and second light intensity data collected at a time that is a preset time interval earlier than the current time, a step of adjusting the shading rate of the shading area in the shading screen according to the light intensity of the driving environment comprises:
calculating a light intensity increment of the first light intensity data compared to the second light intensity data;
determining whether the light intensity increment is greater than a first threshold;
increasing the shading rate of the shading area in the shading screen if the light intensity increment is greater than the first threshold.

14. The vehicle driving shading method according to claim 12, wherein a step of adjusting the shading rate of the shading area in the shading screen according to the light intensity of the driving environment comprises:
monitoring a continuous increment in the light intensity of the driving environment;
determining whether the continuous increment is greater than a second threshold;
calculating a time difference between a current time of the continuous increment and a start time of the continuous increment if the continuous increment is greater than the second threshold;
determining whether the time difference is greater than a third threshold; and
increasing the shading rate of the shading area in the shading screen if the time difference is less than the third threshold.

15. The vehicle driving shading method according to claim 12, further comprising:
collecting a first image outside a cab at a first relative position of the shading screen;
collecting a second image in the cab at a second relative position of the shading screen;
analyzing first position information of a light source in the first image according to the first image, analyzing second position information of human eyes in the second image according to the second image, and adjusting a position of the shading area from the shading screen according to the first relative position, the second relative position, the first position information of the light source, and the second position information of the human eyes.

16. The vehicle driving shading method according to claim 15, further comprising:
acquiring a time period in which the current time is located;
determining whether the time period in which the current time is located is in a first time period;
setting a contour of the shading area to a preset contour if the current time is in the first time period;
generating an outer contour of the shading area according to position information of an outer contour of the light source if the current time is not in the first time period, wherein the first position information of the light source in the first image has the position information of the outer contour of the light source.
